(19) United States
(12) Patent Application Publication
(10) Pub. No.: US 2004/0122695 A1
(43) Pub. Date: Jun. 24, 2004

(54) System and method for management of quotations

(76) Inventor: Ming-Fang Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/661,999

(22) Filed: Sep. 12, 2003

(30) Foreign Application Priority Data
Dec. 20, 2002 (TW) 91136970

(51) Int. Cl. G06F 17/60

(52) U.S. Cl. 705/1; 705/400

(57) ABSTRACT

A system for management of quotations includes a database (14), an application server (12), and a number of client computer (10) located in different places. The database (14) is used to store relevant information. The application server (12) is used to confirm quoted price and generate a quotation. The application server (12) includes an information maintaining module (21), a standard price confirming module (22), a contract price confirming module (23), a quote price confirming module (24), and a quotation generating module (25). The client computer (10) is used for users to access the application server (12). A related method is also provided.

### BACKGROUND OF THE INVENTION

1. Field of the Invention

The present invention relates to systems and methods for management of quotations, and particularly to a system and method which can automatically confirm a quoted price and generate a quotation.

2. Background of the Invention

Efficient management of quotations is important to enterprises, because each properly quoted price can bring more orders, more profits, and more customers. With the popular usage of computer technology and information technology, it is now commonplace for enterprises to integrate information using business management systems. In the field of management of quotations, full use of computer resources is of course desired. However, conventional business management systems and methods have certain shortcomings. A pertinent example is a method for management of quotations as disclosed in P.R. China Patent No. CN1359084A, issued on Jul. 17, 2002 and entitled “Platform For Trade Information Processing And Method For Processing Trade Information.” The patent provides a trade information processing platform for buyers. The platform stores a material requirements database, a supplier database, a material number index database, an inquiry database, and an order database. The platform can generate inquiry bills, quotations and orders according to the information on material requirements, material number indexes and suppliers. However, the platform cannot satisfactorily provide means for confirming quoted prices.

A system and method for management of quotations which overcomes the above-mentioned shortcomings is desired.

### SUMMARY OF THE INVENTION

An object of the present invention is to provide a system for management of quotations which automatically confirms a quoted price, generates a quotation, transmits the quotation to a customer and stores the quotation in a database.

Another object of the present invention is to provide a method for management of quotations which automatically confirms a quoted price, generates a quotation, transmits the quotation to a customer and stores the quotation in a database.

To achieve the above objects, the present invention provides a system for management of quotations. The system comprises a database for storing information on channel products and contracts, preset formulas, and the quotations; an application server for receiving input information, processing the information, and generating quotations, the application server comprising: an information maintaining module for adding, modifying, searching, and deleting information on channel products and contracts; a standard price confirming module for confirming a standard price of each channel product, wherein the standard price is an average price of each channel product; a contract price confirming module for confirming a contract price of each product, wherein the contract price is an average price of each contract product; a quoted price confirming module for comparing the standard price and the contract price of the product and confirming a quoted price; and a quotation generating module for generating a quotation, transmitting the quotation to the customer and storing the quotation in the database; and a plurality of client computers for providing interface for users to maintain information.

The present invention further provides a preferred method for management of quotations, which comprises the following steps: (a) maintaining information on each channel product and information on each contract; (b) judging whether there are any contracts related with a specific customer stored in a database; (c) searching for the channel products' prices and calculating a standard price and storing the standard price in the database if there is no contract related with the customer stored in the database; (d) searching for the contracts information and calculating an average price of the contracts prices and stores the result in the database if there are contracts related with the customer stored in the database; (e) confirming a quoted price according to the standard price and the contract price; and (f) generating a quotation according to the quoted price, transmitting the quotation to the customer and storing the quotation in the database.

Other objects, advantages and novel features of the present invention will be drawn from the following detailed description of preferred embodiments of the present invention with the attached drawings, in which:

### BRIEF DESCRIPTION OF THE DRAWINGS

FIG. 1 shows hardware infrastructure of a system for management of quotations in accordance with a preferred embodiment of the present invention;

FIG. 2 is a block diagram of function modules of an application server of the system of FIG. 1;

FIG. 3 illustrates an exemplary channel product information table according to the present invention;

FIG. 4 illustrates an exemplary contract information table according to the present invention; and

FIG. 5 is a flow chart of the preferred method for management of quotations, in accordance with the present invention.

### DETAILED DESCRIPTION OF THE PREFERRED EMBODIMENT

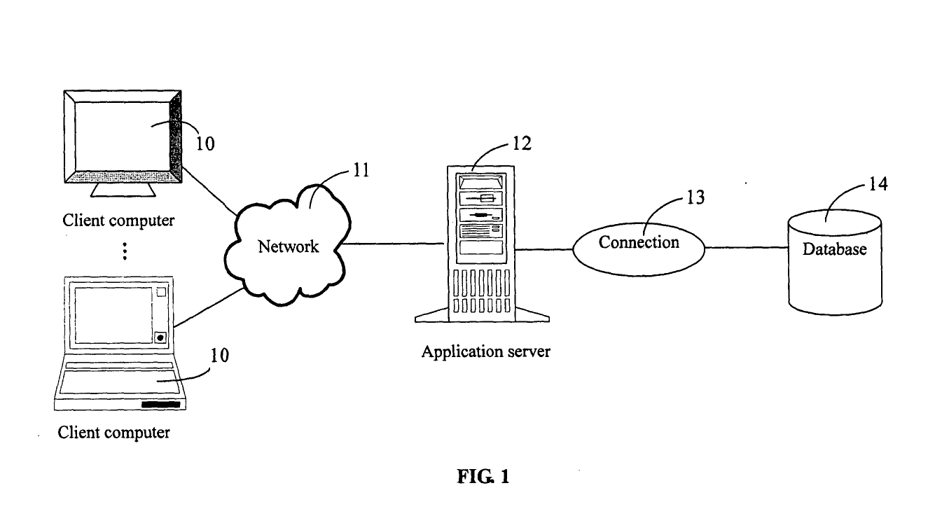

FIG. 1 shows hardware infrastructure of a system for management of quotations in accordance with the preferred embodiment of the present invention. The system comprises a plurality of client computers 10, an application server 12, and a database 14. The client computers 10 are connected with the application server 12 via a network 11, and the database 14 is connected with the application server 12 via a connection 13. The network 11 can be the Internet, an intranet, or another suitable means of electronic communication. The connection 13 is a kind of database connection, which can be an Open Database Connectivity (ODBC), a Java.Database Connectivity (JDBC) or another suitable kind of connectivity. The client computers 10 are located in various different places of an organization employing the system for management of quotations, and provide interfaces for users to maintain information. The application server 12 comprises function modules for receiving input information, processing the information, and returning results. The results are used to confirm quoted prices and generate quotations. The database 14 is used for storing information on channel products, information on contracts, preset formulas, and the quotations. Channel products means products sold through sales and trade channels.

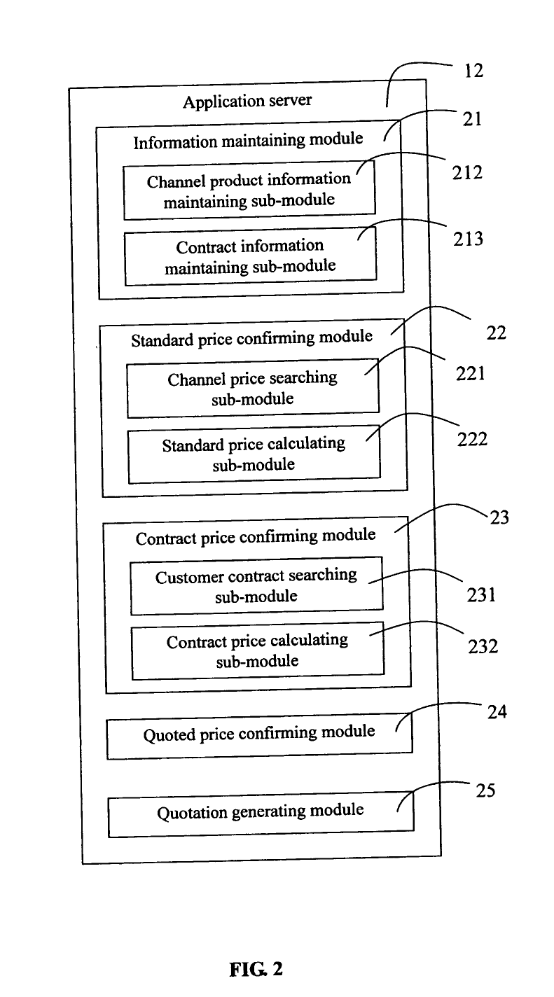

FIG. 2 is a block diagram of function modules of the application server 12. The application server 12 comprises an information maintaining module 21, a standard price confirming module 22, a contract price confirming module 23, a quoted price confirming module 24, and a quotation generating module 25.

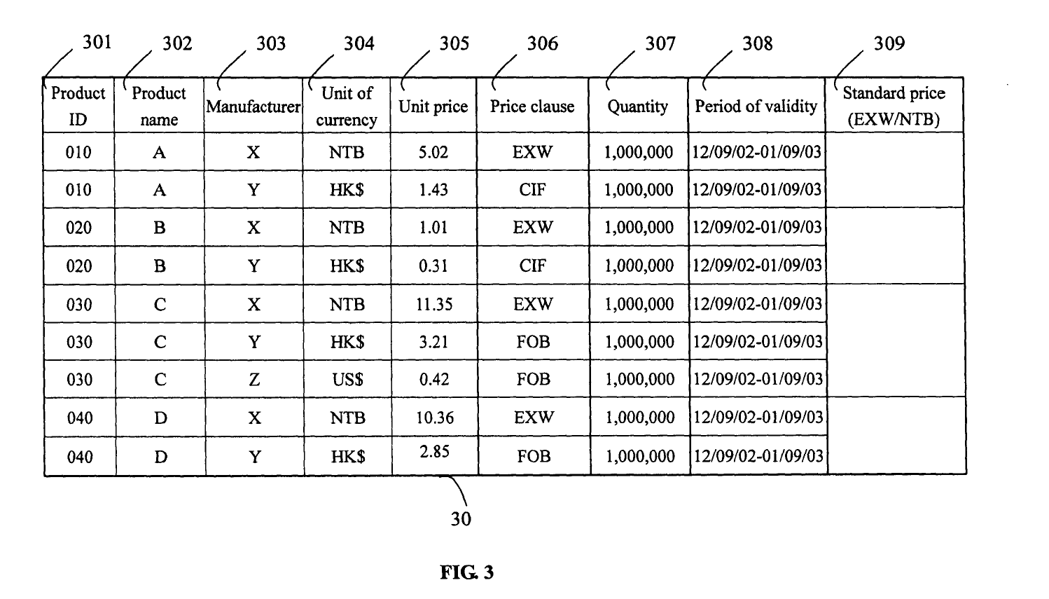

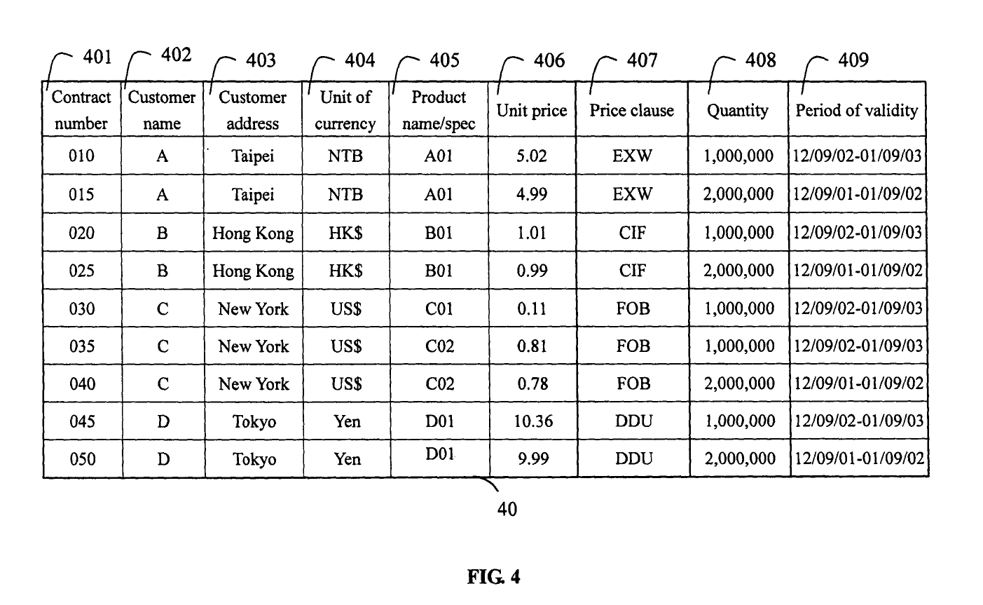

The information maintaining module 21 is used to add, modify, search, and delete information on channel products and contracts stored in the database 14. The information maintaining module 21 comprises a channel product information maintaining sub-module 212, and a contract information maintaining sub-module 213. The channel product information maintaining sub-module 212 is used to add, modify, search, and delete information in a channel product information table 30 (such as that shown in FIG. 3) stored in the database 14. The contract information maintaining sub-module 213 is used to add, modify, search, and delete information in a contract information table 40 (such as that shown in FIG. 4) stored in the database 14.

The standard price confirming module 22 is used for confirming a standard price of a product. The standard price is an average price calculated according to prices recorded in the channel product information table 30 and according to the preset formulas. The standard price confirming module 22 comprises a channel price searching sub-module 221, and a standard price calculating sub-module 222. The channel price searching sub-module 221 is used to search the channel price of a product recorded in the channel product information table 30 stored in the database 14. The standard price calculating sub-module 222 is used for calculating the standard price of the channel product according to the information in the channel product information table 30 and the preset formulas. The calculated standard price of the channel product is then stored in the channel product information table 30.

The contract price confirming module 23 is used for confirming a contract price of each product. The contract price confirming module 23 comprises a customer contract searching sub-module 231, and a contract price calculating sub-module 232. The customer contract searching sub-module 231 is used for searching the contract price of the product in the contract information table 40 stored in the database 14. The contract price calculating sub-module 232 is used for calculating the average price of the contract product according to the information in the contract information table 40 stored in the database 14, and storing the contract price of the contract product in the contract information table 40.

The quoted price confirming module 24 is used for comparing the standard price and the contract price of the product and confirming a quoted price.

The quotation generating module 25 is used for generating a quotation according to the quoted price and the customer information stored in the contract information table 40, transmitting the quotation to the relevant customer, and storing the quotation in the database 14.

FIG. 3 illustrates an exemplary channel product information table 30 according to the present invention. The channel product information table 30 is stored in the database 14, and includes information on channel products. The channel product information table 30 comprises the following fields: product ID 301, product name 302, manufacturer 303, unit of currency 304, unit price 305, price clause 306, quantity 307, period of validity 308, and standard price (EXW/NTB) 309. Product ID 301 is used to record an identification number of each product. Product name 302 is used to record the name of the product. Manufacturer 303 is used to record the manufacturer's name of the product. Unit of currency 304 is used to record a preferred currency that each manufacturer uses. Unit price 305 is used to record the quoted price that each manufacturer provides. Price clause 306 is used to record the price clause that each manufacturer uses to provide the unit price. Quantity 307 is used to record the maximum quantity of the product that the manufacturer can provide. Period of validity 308 is used to record the period of validity of the quotation of the product that the manufacture provides. Standard price (EXW/NTB) 309 is used to record the standard price calculated by the standard price calculating sub-module 222 which uses EXW as its price clause and NTB as its unit of currency.

FIG. 4 illustrates an exemplary contract information table 40 according to the present invention. The contract information table 40 is stored in the database 14, and includes information on contracts. The contract information table 40 comprises the following fields: contract number 401, customer name 402, customer address 403, unit of currency 404, product name/specification 405, unit price 406, price clause 407, quantity 408, and period of validity 409. Contract number 401 is used to record an identification number of each contract. Customer name 402 is used to record the name of the customer. Customer address 403 is used to record the address of the customer. Unit of currency 404 is used to record a preferred currency that each contract stipulates. Product name/spec 405 is used to record the name and specification of the product in each contract. Unit price 406 is used to record the unit price in each contract. Price clause 407 is used to record the price clause used in each contract. Quantity 408 is used to record the quantity of the product in each contract. Period of validity 409 is used to record the period of validity of each contract.

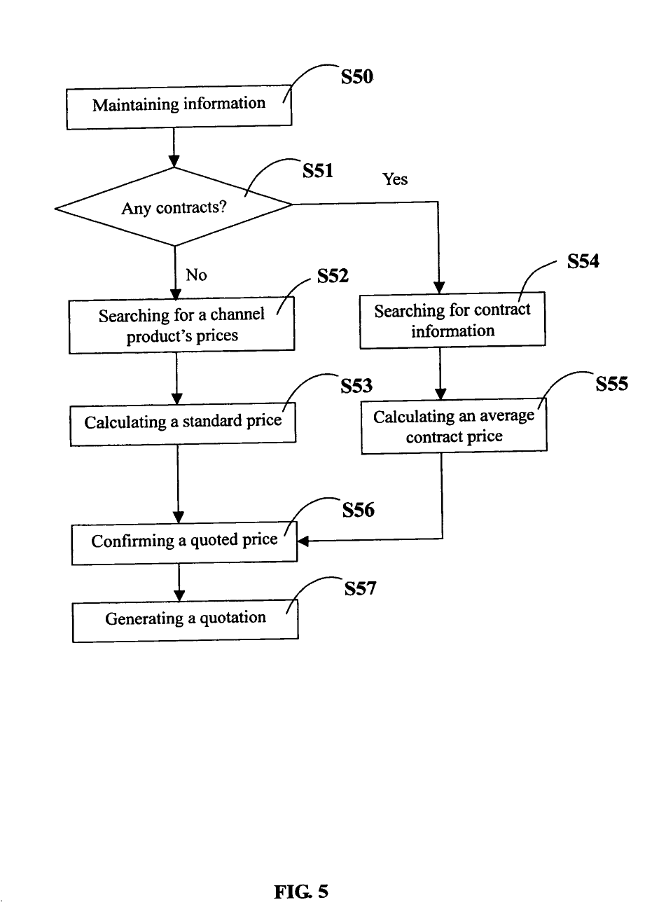

FIG. 5 is a flow chart of a preferred method for management of quotations, in accordance with the present invention. The method is implemented in the above-described system for quoting management. In step S50, a user maintains the information on channel products and contracts via the information maintaining module 21. In step S51, the information maintaining module 21 determines whether there are any relevant contracts with a particular customer stored in the database 14. If there are no contracts with the customer stored in the database 14, in step S52, the channel price searching sub-module 221 searches information on a channel product's prices. In step S53, the standard price calculating sub-module 222 calculates a standard price according to the price information of the channel products, and stores the standard price in the channel product information table 30, whereupon the procedure goes directly to step S56 described below. If there are contracts with the customer stored in the database 14, in step S54, the customer contract searching sub-module 231 searches the relevant contract information in the contract information table 40. Then in step S55, the contract price calculating sub-module 232 calculates an average price of the contracts prices, and stores the result in the contract information table 40, whereupon the procedure goes directly to step S56. In step S56, the quoted price confirming module 24 confirms a quoted price according to the standard price or the average contract price. In step S57, the quotation generating module 25 generates a quotation according to the quoted price, transmits the quotation to the customer, and stores the quotation in the database.

In general, the system and method of the present invention for management of quotations may take forms other than what is described above. While preferred embodiments for carrying out the invention have been described in detail, those familiar with the art to which the invention relates will recognize various alternative designs and embodiments for practicing the invention. These alternative embodiments are also within the scope of the present invention. The scope of the present invention is defined by the claims appended hereto and allowable equivalents thereof.

What is claimed is:

1. A system for management of quotations, the system comprising:
a database for storing information on channel products and contracts, preset formulas, and quotations;
an application server for receiving input information, processing the information, and generating quotations, the application server comprising:
an information maintaining module for adding, modifying, searching, and deleting information on channel products and contracts stored in the database;
a standard price confirming module for confirming a standard price of each product, wherein the standard price is an average price of each channel product;
a contract price confirming module for confirming a contract price of each product, wherein the contract price is an average price of each contract product;
a quoted price confirming module for comparing the standard price and the contract price of the product and confirming a quoted price; and
a quotation generating module for generating a quotation, transmitting the quotation to the customer and storing the quotation in the database; and
a plurality of client computers for providing interfaces for users to maintain information.

2. The system for management of quotations as described in claim 1, wherein the information maintaining module comprises:
a channel product information maintaining sub-module for adding, modifying, searching, and deleting information in a channel product information table stored in the database; and
a contract information maintaining sub-module for adding, modifying, searching, and deleting information in a contract information table stored in the database.

3. The system for management of quotations as described in claim 1, wherein the standard price confirming module comprises:
a channel price searching sub-module for searching the channel price of a product; and
a standard price calculating sub-module for calculating the standard price of the channel product according to the information and the preset formulas stored in the database.

4. The system for management of quotations as described in claim 1, wherein the contract price confirming module comprises:
a customer contract searching sub-module for searching the contract price of a product stored in the database; and
a contract price calculating sub-module for calculating the average price of the contract product according to the information stored in the database and storing the contract price of the contract product in the database.

5. A method for management of quotations, the method comprising the following steps:
(a) maintaining information on channel products and contracts;
(b) determining whether there are any relevant contracts relating to a particular customer stored in a database;
(c) confirming a standard price for each channel product if there are no contracts relating to the customer stored in the database;
(d) confirming a contract price for each contract product if there are one or more contracts relating to the customer stored in the database;
(e) confirming a quoted price according to the standard price or the contract price; and
(f) generating a quotation according to the quoted price.

6. The method for management of quotations as described in claim 5, wherein step (c) comprises the steps of:
searching prices of channel products; and
calculating the standard price and storing the standard price in the database.

7. The method for management of quotations as described in claim 5, wherein step (d) comprises the steps of:
searching contract information; and
calculating an average price of contract prices, and storing the result in the database.

8. The method for management of quotations as described in claim 5, further comprising the step of transmitting the quotation to the customer and storing the quotation in the database.

9. A medium including encoded logic for management of quotations, comprising the logic operable to:
maintain information on channel products and contracts;
determine whether there are any relevant contracts relating to a particular customer stored in a database;
confirm a standard price for each channel product if there are no contracts relating to the customer stored in the database;
confirm a contract price for each contract product if there are one or more contracts relating to the customer stored in the database;
confirm a quoted price according to the standard price or the contract price; and
generate a quotation according to the quoted price.
